(19) United States
(12) Patent Application Publication
(10) Pub. No.: US 2014/0054111 A1
(43) Pub. Date: Feb. 27, 2014

(54) LADDER BALANCE ADJUSTING APPARATUS

(71) Applicant: WEN-HUA LU, New Taipei City (TW)

(72) Inventor: WEN-HUA LU, New Taipei City (TW)

(21) Appl. No.: 13/596,003

(22) Filed: Aug. 27, 2012

(51) Int. Cl. E06C 7/44

(52) U.S. Cl. 182/107

(57) ABSTRACT

A ladder balance adjusting apparatus installed on an n-shaped ladder leg includes an assembly, a base cover, a fixing element, a base cup, a stand rod, and a control element. The assembly has a first component and a second component, and the second component has a side and a bottom to form an L-shaped structure, and after the ladder leg is installed between the two components, the ladder leg is locked by a plurality of locking elements. The base cover is coupled to the assembly and the base cup, and the fixing element is built in the base cover, and the stand rod is provided for passing the aforementioned elements to support the ladder leg, and the control element is provided for controlling the fixing element to adjust the height of the ladder leg, and to simplify the manufacturing process of components, the installation and disassembly of the apparatus.

### BACKGROUND OF THE INVENTION

1. Field of the Invention

The present invention relates to the technical field of ladder assisting support base or base, in particular to a ladder balance adjusting apparatus featuring a low production cost and simplifying the assembling and disassembling procedures by using a two-piece assembly.

2. Description of the Related Art

In general, an adjusting device simply comprised of a foot pad and a bolt is installed to each foot of a mechanical device to overcome a height difference and improve the stability of a ladder, a scaffold, an instrument or a piece of furniture installed on the ground, and also secure a knob bolt after the height of each foot pad is adjusted. The conventional adjusting procedure by pulling and turning repeatedly not only incurs an inconvenient use, but also takes much time and fails to meet the required efficiency. To overcome the aforementioned problem, R.O.C. Pat. No. TW 1301179 discloses a “Quick stand adjusting apparatus” as shown in FIGS. 1 and 2, wherein a hollow foot 10 is sheathed on a foot of the mechanical device, and a stand rod 11 is provided for the support, and then a transmission rod 12 is provided for rotating a movable latch 13 to push a fastener 14 into a concave chamber of a latch cover 15 or pull the fastener 14 out from the latch cover 15, so that the fastener 14 can be engaged to or loosened from the stand rod 11. Therefore, users can turn the transmission rod 12 to adjust the length of the stand rod 11 and adjust the height of the foot, so as to enhance the erect stability and using safety of the mechanical device.

The stand 10 of the aforementioned patent is installed corresponding to the foot of the mechanical device, and the stand adjusting device 1 is installed to the foot by an embedding method. However, the aforementioned adjusting device is incompatible to some of the mechanical devices due to the limitation of the fixed structural dimensions and shape of the stand 10, so that such adjustment device has low applicability and popularity. In addition, the fastener 14 comprises of two petal pieces, so that the insufficient engaging area between the stand rods 11 results in an insufficient holding force, and the stand rods 11 may slide or fall down easily to give rise to a safety issue. The movable latch 13 abuts the fastener 14 for long and may be worn out or damage to affect the adjusting effect. In view of the aforementioned problems, it is a main subject for the present invention to improve the structure of the stand 10 to enhance the applicability with quick and convenient installation and disassembly.

### SUMMARY OF THE INVENTION

In view of the problems of the prior art, it is a primary objective of the present invention to provide a ladder balance adjusting apparatus with a two-piece assembly to lower the production cost and decrease the level of difficulty for installation and disassembly, so that the apparatus can be used extensively and universally.

To achieve the foregoing objective, the present invention provides a ladder balance adjusting apparatus applied and installed to an n-shaped ladder leg of a foldable ladder, for supporting and adjusting the height of the ladder leg to securely install the foldable ladder, comprising: an assembly, a base cover, a fixing element, a base cup, a stand rod, a foot disc and a control element, and the stand rod is a circular rod with a plurality of first threads formed on a surface of the stand rod and a connection portion of a sphere disposed at an end of the stand rod and embedded into the foot disc in a circular shape, and the base cup, the fixing element, the base cover and the assembly are installed at the other end of the stand rod; and the base cover is a tapered hollow cone fixed to the assembly and having a containing chamber formed therein for receiving the fixing element; the base cup is covered by the base cover and the fixing element is sealed into the containing chamber; the control element is having a gasket, a pair of first springs, a pull rod and a pull string, and the pull string is coupled to the pull rod, and the pull rod is pivotally coupled to the bottom of the base cup, and the pair of first springs are having an end coupled to the pull rod and the other end coupled to a side of the gasket, and the other side of the gasket is abutting the fixing element; the fixing element is comprising three petal pieces disposed around the stand rod and connected to form a hollow cone, and an external wall of each of the petal pieces is an oblique conical surface, and a plurality of second threads are formed at a lower edge of an internal wall of each of the petal pieces, such that when the containing chamber compresses the oblique conical surfaces to fold the petal pieces, the second threads are engaged with the first threads, characterized in that the assembly comprises a first component and a second component, and the second component has a side and a bottom to form an L-shaped structure, and the bottom of the second component is fixed to the base cover and has a through hole formed at the center of the bottom of the second component for receiving the stand rod, and after the ladder leg is placed between the first component and the second component and locked by a plurality of locking elements, so that the first component and the second component clamp and fix the ladder leg. Therefore, the two-piece assembly allows the present invention to adapt ladder legs of different sizes, so as to improve the applicability of the product significantly.

Wherein, the first component is in the shape of a square disc; the fixing element includes a binding element sheathed on the petal pieces, and when the containing chamber compresses the petal pieces, the petal pieces are folded and the binding element is stretched, and when the pull string is pulled by the pull rod to rotate in a direction opposite to the containing chamber to drive the gasket and the fixing element away from the containing chamber, the petal pieces are spread open to bind the binding element; the binding element is a spring strap having an end with decreased diameter and width and the other end is embedded to form a spring coil; the spring strap has a force constant of 0.2˜0.8 kgf/cm; each of the petal pieces has an arc groove formed on a side of the petal piece and an arc bump formed on the other side of the petal piece, and the arc groove and the arc bump are disposed opposite to each other and coupled to form a twisting portion used as a fulcrum for swinging each of the petal pieces inwardly and outwardly; the control element further includes a control knob installed at the assembly and coupled to the pull string for pulling the pull string; the base cup is abutted and coupled to the pull rod through a second spring, and when the pull string pulls the pull rod to rotate the pull rod in a direction opposite to the containing chamber and compress the second spring, the pull rod is rotated in a direction towards the containing chamber by a resilience force of the second spring.

Through the principle of mechanics of the control knob and the second spring, the fixing element can be engaged to the stand rod with an adjusted height to improve the practicality of the product.

### BRIEF DESCRIPTION OF THE DRAWINGS

FIG. 1 is a schematic view of an application as disclosed in R.O.C. Pat. No. TW 1301179;

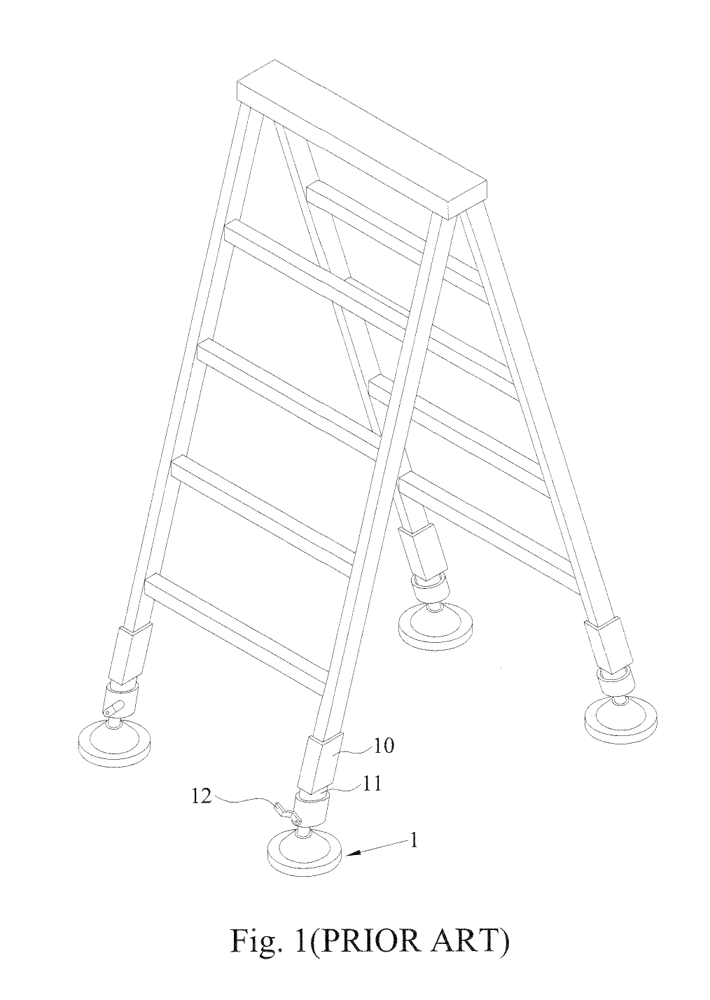

FIG. 2 is a cross-sectional view of a structure as disclosed in R.O.C. Pat. No. TW 1301179;

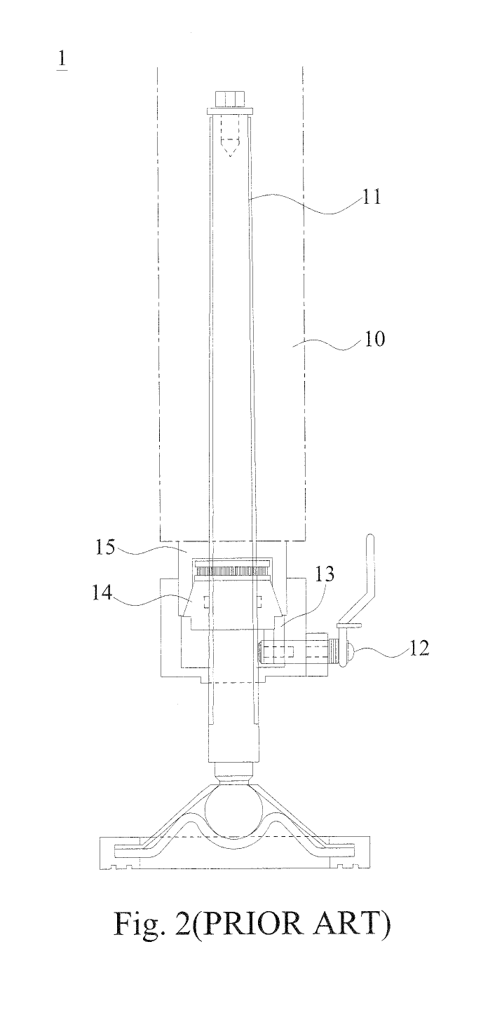

FIG. 3 is an exploded view of a preferred embodiment of the present invention;

FIG. 4 is a perspective view of a preferred embodiment of the present invention;

FIG. 5 is a schematic view of an operation of a preferred embodiment of the present invention;

FIG. 6 is another schematic view of an operation of a preferred embodiment of the present invention; and

FIG. 7 is a schematic view of an application of a preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

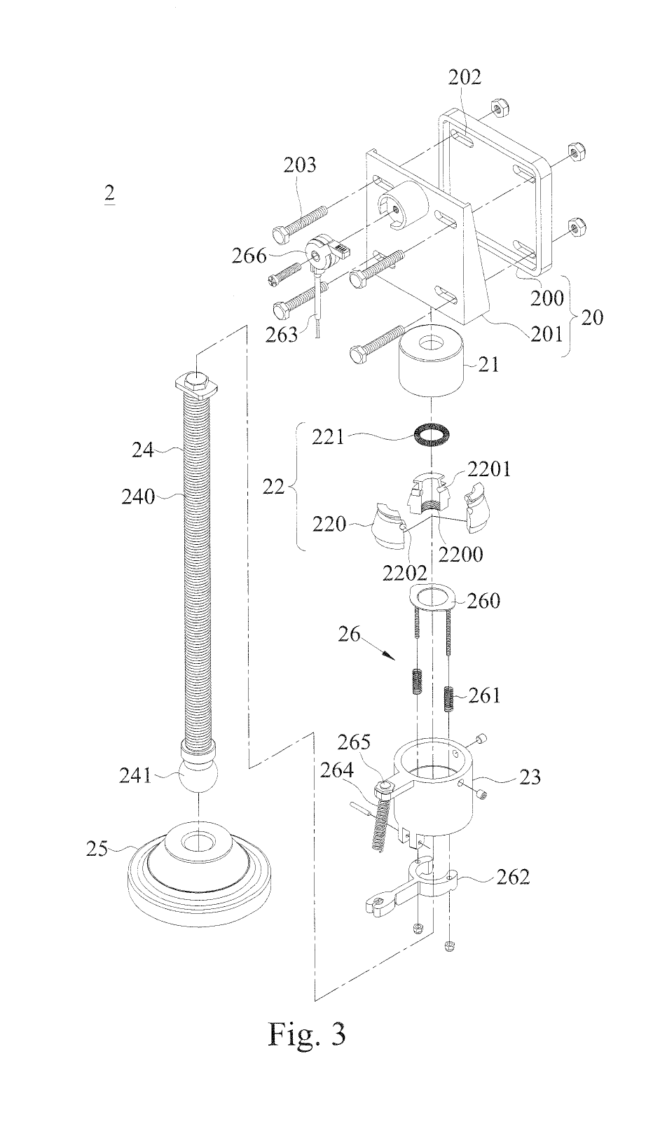

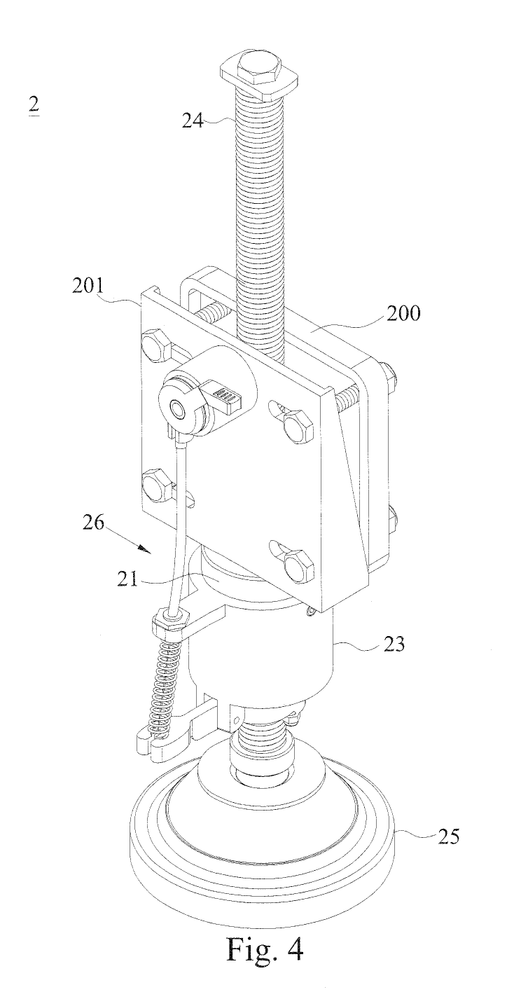

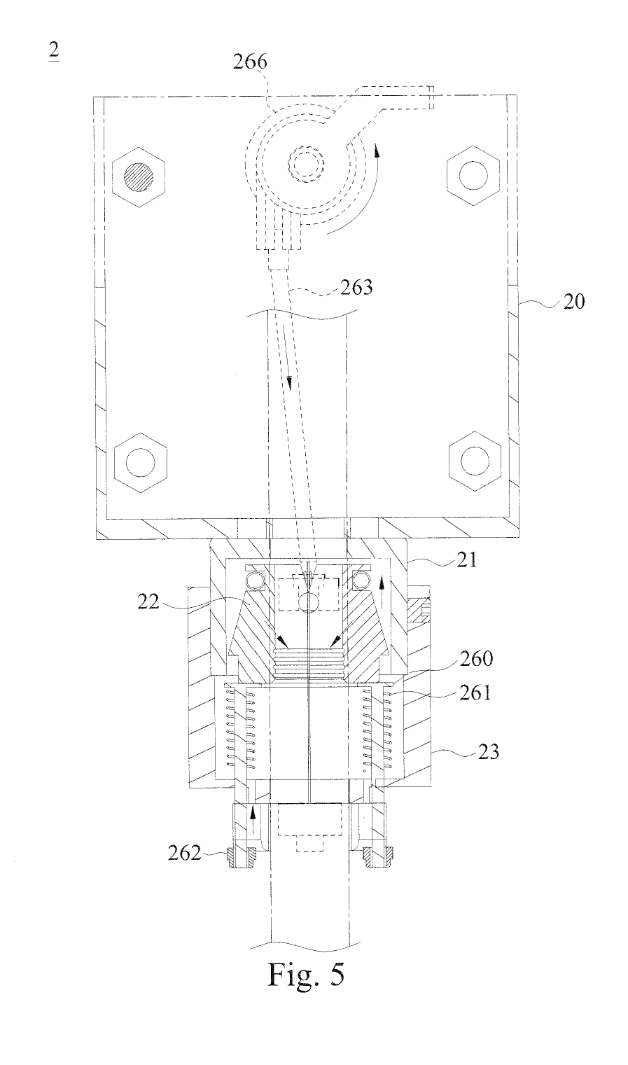

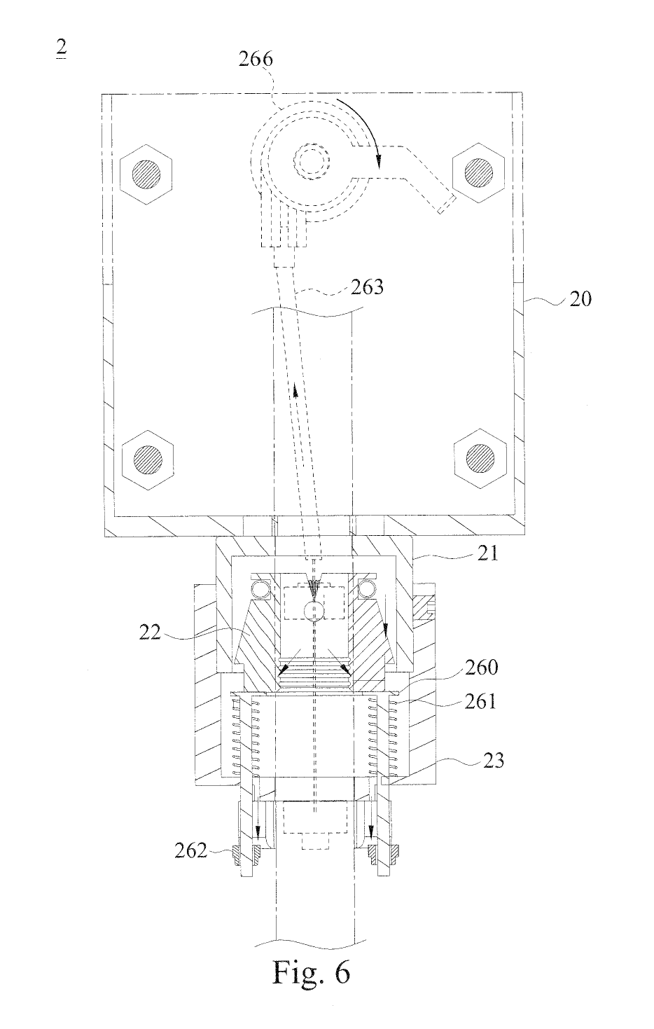

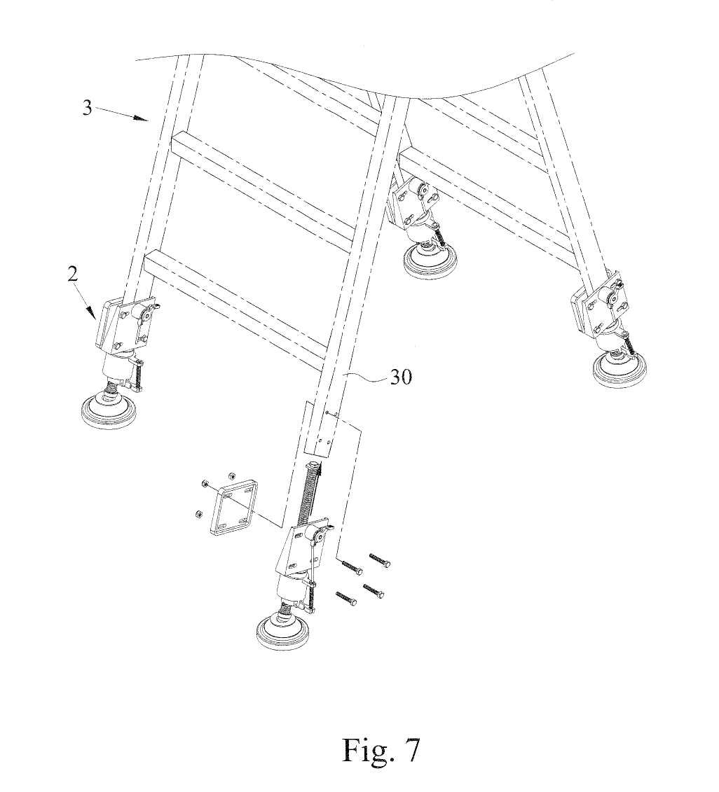

With reference to FIGS. 3 to 7 for an exploded view, a perspective view, and schematic views of an operation and an application of a preferred embodiment of the present invention, a ladder balance adjusting apparatus 2 is applied for adjusting the height of a foot of a mechanical device such as a ladder, a scaffold, an instrument or a piece of furniture. For example, the ladder balance adjusting apparatus 2 is installed to an n-shaped ladder leg 30 of a foldable ladder 3 to support and adjust the height of the ladder leg 30 and erect the foldable ladder 3 stably. The ladder balance adjusting apparatus 2 comprises an assembly 20, a base cover 21, a fixing element 22, a base cup 23, a stand rod 24, a foot disc 25 and a control element 26, wherein the stand rod 24 is a circular rod having a plurality of first threads 240 formed on a surface of the stand rod 24, and the base cup 23, the fixing element 22, the base cover 21 and the assembly 20 are passed through an end of the stand rod 24, and a connection portion 241 of a sphere is disposed at the other end of the stand rod 24 and embedded into the foot disc 25 in a circular shape for allowing the ladder balance adjusting apparatus 2 to movably adjust an angle in different directions. The assembly 20 includes a first component 200 and a second component 201, and the first component 200 is in the shape of a square disc, and the second component 201 is a L-shaped structure having a side and a bottom, and lateral portions of the first component 200 and the second component 201 have a plurality of long locking holes 202 formed thereon and opposite to one another. The second component 201 is coupled to the base cover 21 through the bottom of the second component 201, and a through hole is formed at the center of the bottom of the second component 201 for receiving the stand rod 24. After the ladder leg 30 is abutted against the bottom and disposed between the first component 200 and the second component 201, a plurality of locking elements 203 pass through the locking holes 202 (such as a bolt-and-screw connection), so that the ladder leg 30 is clamped and fixed by the first component 200 and the second component 201. By flexibly adjusting the locking distance between the first component 200 and the second component 201 and adjusting the position to the left or right for each locking element 203 to pass through each respective locking hole 202, the applicability can be enhance to allow the invention to be used extensively in various different mechanical devices.

The slightly tapered hollow cone of the base cover 21 has a containing chamber defined in the inverted conical space for containing the fixing element 22, and the base cup 23 is covered onto the bottom of the base cover 21 to seal the fixing element 22 in the containing chamber. The control element 26 includes a gasket 260, a pair of first springs 261, a pull rod 262, a pull string 263, a second spring 264, a guide element 265 and a control knob 266, wherein the control knob 266 is a rotary handle installed in the assembly 20. For example, a side of the second assembly 201 is coupled to the pull string 263 to facilitate users to pull the pull string 263 easily by pressing. The guide element 265 is a hollow lock wire secured onto the base cup 23, and the second spring 264 is abutted between the base cup 23 and the pull rod 262, and the pull string 263 is passed through the guide element 265 and the second spring 264 and then coupled to the pull rod 262. The pull rod 262 is pivotally coupled to the bottom of the base cup 23, and ends of the pair of first springs 261 are coupled to the pull rod 262 and the other ends of the first springs 261 are sheathed on a bolt on a side of the gasket 260 and abutted against a side of the gasket 260. With the bolt, the gasket 260 is fixed to the pull rod 262, and the other side is abutted and coupled to the fixing element 22.

In addition, the fixing element 22 is comprised of three petal pieces 220 and a binding element 221, wherein the binding element 221 is a spring strap having a force constant of 0.2˜0.8 kgf/cm and the binding element 221 has a tapered end for being embedded into the other end to form a spring coil and sheathing the petal pieces 220. The petal pieces 220 are disposed around the stand rod 24 and folded into a hollow cone, and an external wall of each of the petal pieces 220 is an oblique conical surface, and a plurality of second threads 2200 is formed on an internal wall of each petal piece 220, wherein an arc groove 2201 is formed on a side of the petal piece 220 and an arc bump 2202 formed on the other side of the petal piece 220, and each arc groove 2201 and each arc bump 2202 are disposed opposite to each other and coupled to form a twisting portion used as a fulcrum for swinging each of the petal pieces 220 inwardly and outwardly, so as to enhance the motion sensitivity of the fixing element 22. Therefore, when a user turns and presses the control knob 266 to pull the pull string 263 to compress the second spring 264 and rotate the pull rod 262 in a direction opposite to the containing chamber, and move the gasket 260 coupled to the pull rod 262 away from the containing chamber, and drive the fixing element 22t to move downwardly to separate the containing chamber, the binding element 221 is closed up and the petal pieces 220 are spread open to loosen the second threads 2200 from the first threads 240. In other words, the fixing element 22 loosens the stand rod 24, so that users can pull the stand rod 24 freely to adjust the height of the ladder leg 30. On the other hand, when the user releases the control knob 266, the pull rod 262 rotates towards the containing chamber by the resilience force of the second spring 264, and the gasket 260 pushes the fixing element 22 to move upwardly into the containing chamber, and an internal wall of the containing chamber is attached to the oblique conical surfaces closely to compress the petal pieces 220, so that the fixing element 22 is folded and the second threads 2200 are engaged with the first threads 240, and the petal pieces 220 are folded, and the binding element 221 is stretched.

While the invention has been described by means of specific embodiments, numerous modifications and variations could be made thereto by those skilled in the art without departing from the scope and spirit of the invention set forth in the claims.

In summation of the description above, the present invention improves over the prior art and complies with patent application requirements, and thus is duly filed for patent application.

What is claimed is:

1. A ladder balance adjusting apparatus, applied and installed to an n-shaped ladder leg of a foldable ladder, for supporting and adjusting the height of the ladder leg to securely install the foldable ladder, comprising: an assembly, a base cover, a fixing element, a base cup, a stand rod, a foot disc and a control element, and the stand rod being a circular rod with a plurality of first threads formed on a surface of the stand rod and a connection portion of a sphere disposed at an end of the stand rod and embedded into the foot disc in a circular shape, and the base cup, the fixing element, the base cover and the assembly being installed at the other end of the stand rod; and the base cover being a tapered hollow cone fixed to the assembly and having a containing chamber formed therein for receiving the fixing element; the base cup being covered by the base cover and the fixing element being sealed into the containing chamber; the control element having a gasket, a pair of first springs, a pull rod and a pull string, and the pull string being coupled to the pull rod, and the pull rod being pivotally coupled to the bottom of the base cup, and the pair of first springs having an end coupled to the pull rod and the other end coupled to a side of the gasket, and the other side of the gasket abutting the fixing element; the fixing element comprising three petal pieces disposed around the stand rod and connected to form a hollow cone, and an external wall of each of the petal pieces being an oblique conical surface, and a plurality of second threads being formed at a lower edge of an internal wall of each of the petal pieces, such that when the containing chamber compresses the oblique conical surfaces to fold the petal pieces, the second threads are engaged with the first threads, characterized in that the assembly comprises a first component and a second component, and the second component has a side and a bottom to form an L-shaped structure, and the bottom of the second component is fixed to the base cover and has a through hole formed at the center of the bottom of the second component for receiving the stand rod, and after the ladder leg is placed between the first component and the second component and locked by a plurality of locking elements, so that the first component and the second component clamps and fixes the ladder leg.

2. The ladder balance adjusting apparatus of claim 1, wherein the first component is in the shape of a square disc.

3. The ladder balance adjusting apparatus of claim 2, wherein the fixing element includes a binding element sheathed on the petal pieces, and when the containing chamber compresses the petal pieces, the petal pieces are folded and the binding element is stretched, and when the pull string is pulled by the pull rod to rotate in a direction opposite to the containing chamber to drive the gasket and the fixing element away from the containing chamber, the petal pieces are spread open to bind the binding element.

4. The ladder balance adjusting apparatus of claim 3, wherein the binding element is a spring strap having an end with decreased diameter and width and the other end being embedded to form a spring coil.

5. The ladder balance adjusting apparatus of claim 4, wherein the spring strap has a force constant of 0.2˜0.8 kgf/cm.

6. The ladder balance adjusting apparatus of claim 5, wherein each of the petal pieces has an arc groove formed on a side of the petal piece and an arc bump formed on the other side of the petal piece, and the arc groove and the arc bump are disposed opposite to each other and coupled to form a twisting portion used as a fulcrum for swinging each of the petal pieces inwardly and outwardly.

7. The ladder balance adjusting apparatus of claim 6, wherein the control element further includes a control knob installed at the assembly and coupled to the pull string for pulling the pull string.

8. The ladder balance adjusting apparatus of claim 7, wherein the base cup is abutted and coupled to the pull rod through a second spring, and when the pull string pulls the pull rod to rotate the pull rod in a direction opposite to the containing chamber and compress the second spring, the pull rod is rotated in a direction towards the containing chamber by a resilience force of the second spring.
